(19) United States
(12) Patent Application Publication
(10) Pub. No.: US 2010/0055795 A1
(43) Pub. Date: Mar. 4, 2010

(54) POROUS MEMBRANES AND METHODS OF MAKING THE SAME

(76) Inventor: Kwangyeol Lee, Namyangju-si (KR)

Correspondence Address: EDWARDS ANGELL PALMER & DODGE LLP, P.O. BOX 55874, BOSTON, MA, 02205, US

(21) Appl. No.: 12/201,947

(22) Filed: Aug. 29, 2008

(51) Int. Cl. G01N 35/00; C09J 5/02; B32B 15/00

(52) U.S. Cl. 436/43; 156/306.3; 428/318.4

(57) ABSTRACT

Methods of making a porous membrane and the applications of the porous membrane are disclosed. One such method includes providing a substrate; and forming a first layer over the substrate. The first layer is formed of a metallic material. The method also includes providing a second layer of oxide particles over the first layer; and pressing the second layer against the first layer such that at least portion of the first layer is inserted into gaps between the oxide particles. The resulting membrane can have various applications, including, but not limited to, a catalyst, in a chemical reaction, a component in an electrical or electronic device, or a filter component.

### BACKGROUND

Nanotechnology generally refers to a field of technology that controls matter on an atomic or molecular scale (typically 100 nanometers or smaller). Nanotechnology is used for the fabrication of devices or materials that lie within the scale.

Nanotechnology has been recently developed rapidly for various applications in a number of technology fields. Examples of such fields include, but are not limited to, applied physics, materials science, interface and colloid science, device physics, molecular chemistry, self-replicating machines and robotics, chemical engineering, mechanical engineering, biological engineering, and electrical engineering. In certain instances, a structure or material made by nanotechnology can be used in a number of different technology fields.

### SUMMARY

An aspect by way of non-limiting example includes a method of making a membrane structure. The method includes: providing a substrate and forming a first layer over the substrate. The first layer is formed of a metallic material. The method also includes providing a second layer of oxide particles over the first layer; and pressing the second layer against the first layer such that at least a portion of the first layer is inserted into gaps between the oxide particles.

Another aspect by way of non-limiting example includes an apparatus that includes a membrane comprising pores formed in a first surface thereof, wherein the pores are distributed in the first surface. The membrane is formed of a metallic material. The membrane has a thickness between about 1 nm and about 100 nm. The pores have an average size between about 3 nm and about 500 nm.

Yet another aspect by way of non-limiting example includes a method of catalyzing a water gas shift reaction. The method can include providing the apparatus described above, and contacting the apparatus with a gas and water.

Yet another aspect by way of non-limiting example includes a method of catalyzing an alcohol-aldehyde reaction. The method can include providing the apparatus described above and contacting the apparatus with an alcohol for a period of time sufficient to convert the alcohol to an aldehyde.

Yet another aspect by way of non-limiting example includes an electronic or electrical device that includes the apparatus described above. Yet another aspect by way of non-limiting example includes a method of sensing biomolecules. The method can include providing the apparatus described above and detecting signals from the apparatus. Another aspect by way of non-limiting example relates to electronic or electrical devices that include an apparatus as described above or elsewhere herein.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The embodiments will be better understood from the Detailed Description and from the appended drawings, which are meant to illustrate and not to limit the embodiments.

FIGS. 1A-1F show an illustrative embodiment of a method of making a porous membrane.

FIG. 2 is a schematic perspective view of an illustrative embodiment of a porous membrane.

FIGS. 3A and 3B show an illustrative embodiment of a method of making a porous membrane.

FIGS. 4A-4C show an illustrative embodiment of method of making a porous membrane.

FIG. 5A is a plan view of an illustrative embodiment of a porous membrane structure.

FIG. 5B is a cross-section of the porous membrane structure of FIG. 5A, taken along lines 5B-5B.

FIGS. 6A and 6B show an illustrative embodiment of method of making a porous membrane structure.

FIG. 7 is a schematic perspective view of an illustrative embodiment of an electrode having a catalyst porous membrane.

FIG. 8 is a schematic perspective view of an illustrative embodiment of an electrode for use in an electrochemical reaction.

FIG. 9 is a schematic cross-sectional view of an illustrative embodiment of a filter including a porous membrane.

### DETAILED DESCRIPTION

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The following detailed description is directed to certain specific embodiments. However, the embodiments can be varied in a multitude of different ways. As will be apparent from the following description, the embodiments may be implemented in or associated with a variety of devices and methods.

In one aspect, a method of making a porous membrane or porous membrane structure is provided. One such method includes forming a first layer with a metallic material over a substrate. The first layer may have a thickness between about 1 nm and several hundred nanometers. Then, a second layer of oxide particles is provided over the first layer. The oxide particles can have an average size between about 10 nm and about 1 μm. The second layer is pressed against the first layer such that at least a portion of the first layer is inserted into gaps between the oxide particles. During this process, the second layer may serve as a mold in forming pores in the first layer.

The porous membrane or membrane structure have various applications. The membrane or membrane structure can be used as a catalyst in, for example, electrochemical reactions, water gas shift reactions, or alcohol-aldehyde reactions. The porous membrane or membrane structure can also be used as a stand-alone electrode or conductive line in various fields. The porous membrane or membrane structure may also form a part of a filter, such as an antibiotic filter. The porous membrane or membrane structure may be used as a component of a magnetic memory device. In other instances, the porous membrane or membrane structure can be used for mass manufacturing of composite materials. A skilled artisan will appreciate that the porous membrane or membrane structure can be used for various other applications.

### Processes for Making Porous Membranes

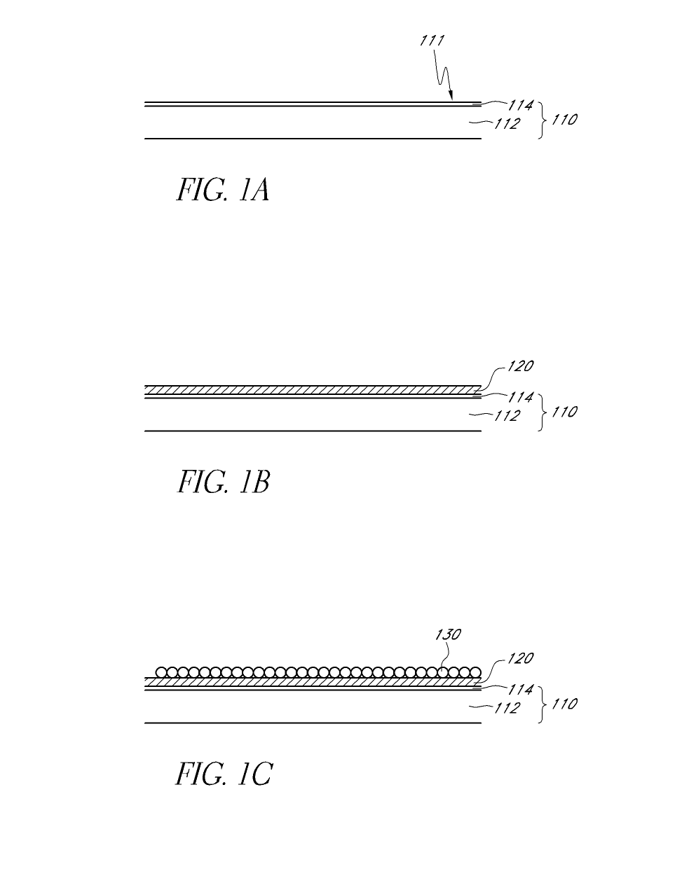

Referring to FIGS. 1A-1F, methods of making a porous membrane according to one or more embodiments will be described below. First, a substrate 110 having a planarized top surface 111 is provided, as shown in FIG. 1A. In one embodiment, the top surface 111 of the substrate 110 may be planarized by, for example, chemical mechanical polishing (CMP).

In one embodiment, the substrate 110 may be a silicon substrate. The substrate 110 can also include a naturally-formed silicon oxide (SiO₂) layer or film 114 that forms the top surface 111. The substrate may have a thickness between about 1 mm and about 10 mm, optionally between about 1 mm and about 5 mm. The thickness can be, for example, about 2 mm or about 3 mm. Such silicon oxide may be referred to as “native silicon oxide,” and may be formed by exposure of the silicon substrate to air. The silicon oxide layer 114 may have a thickness between about 0.5 nm and about 100 nm, or optionally between about 10 nm and about 20 nm. The thickness of the silicon oxide layer 114 may be, for example, about 3 nm, or about 15 nm. A substantial portion 112 of the substrate 110 under the silicon oxide layer 114 is not converted to silicon oxide, and may be referred to as a silicon portion in the context of this document.

In other embodiments, the substrate may be formed of any other suitable material, such as alumina. In such embodiments, the substrate may include a thin layer deposited or naturally formed on a surface thereof The thin layer may have a thickness between about 0.5 nm and about 100 nm, optionally between about 10 nm and about 20 nm. The thin layer may be formed of a material (for example, silicon oxide) that can be removed by a method different from a method for removing the material of the substrate. In certain embodiments, the substrate may not include a thin layer as described above.

A thin metallic layer 120 can be deposited on the silicon oxide layer 114, as shown in FIG. 1B. In one embodiment, the layer 120 may be deposited by an atomic layer deposition (ALD) process. In other embodiments, the layer 120 can be formed by any suitable deposition method, such as chemical vapor deposition, physical vapor deposition, sputtering, eletroless deposition, or the like. The metallic layer 120 can have a thickness of about 1 nm to several hundred nanometers, optionally about 1 nm to about 20 nm, or about 20 nm to about 50 nm. The thickness of the metallic layer 120 may be, for example, about 10 nm or about 30 nm. The metallic layer 120 may be formed of any suitable metallic material(s), depending on the application of the resulting membrane. Examples of metallic materials include, but are not limited to, Ni, Au, Rd, Ru, Ir, Pd, Os, Ag, Au, Cu, Pt, or a composite or alloy of two or more of the foregoing, such as but not limited to, Ru—Pt or Au—Pd.

Oxide particles 130 are provided over the metallic layer 120 such that the oxide particles are closely packed, as shown in FIG. 1C. In the context of this embodiment, the term “close packing” refers to a dense arrangement of particles, such that about 50% to about 100% of the particles contact their neighboring particles. In certain embodiments, the closed-packed oxide particles may take up the greatest possible fraction of the surface of the metallic layer 120. The oxide particles 130 may cover about 50% to about 100%, or about 60% to about 80% of the surface of the metallic layer 120. The oxide particles 130 together serve as an imprint mold for shaping the metallic layer 120, as will be described below. In one embodiment, the oxide particles generally have a spherical shape. It should be understood that the particles can be in various other shapes as well, including for example, cylindrical shape, cubical shape, conical shape, pyramidal shape, or the like. The oxide particles 130 may be formed of an oxide material, such as silicon oxide (SiO₂), cerium oxide (CeO₂ or CeOx), titanium oxide (TiO₂ or TiOx), or the like. In an embodiment where the oxide particles have a spherical shape, the average diameter of the oxide particles 130 may be about 10 nm to about 1 μm, optionally about 10 nm to about 200 nm. In yet another embodiment, the average diameter of the oxide particles 130 may be about 10 nm to about 50 nm. The average diameter of the oxide particles 130 may be optionally about 10 nm to about 30 nm, or about 30 nm to about 100 nm. The average diameter of the oxide particles may be, for example, about 20 nm or about 50 nm. In one embodiment, the oxide particles 130 may be deposited over the metallic layer 120 by Langmuir-Blodgett (LB) technique, stamping, spray-coating, or the like. In such an embodiment, a dispersion containing oxide particles and a surfactant (e.g., citrate, octane thiol, oleic acid, oleyl amine, etc.) is provided over the metallic layer 120.

The oxide particles 130 are pressed against the metallic layer 120. In one embodiment, the structure resulting from the step shown in FIG. 1C is placed between a pair of planar metallic platens 140a, 140b, and the platens 140a, 140b are pressed against each other, such that at least some of the oxide particles 130 penetrate the metallic layer 120 and contact the silicon oxide layer 114, as shown in FIG. 1D. This step can be performed at a pressure of about 1 atm to about 100 atm, or optionally about 2 atm to about 5 atm. This step can be carried out for a period of time between about 1 second and about 1 minute, or optionally between about 5 seconds and about 15 seconds. The period of time can be, for example, about 10 seconds or 30 seconds. The platens 140a, 140b may provide a uniform pressure against the structure. During this step, the structure may be heated to a temperature that is lower than the melting point of the metal or alloy of the metallic layer 120, but is high enough to induce the structural deformation of the metal or alloy while not deforming the metallic platens 140a, 140b. In one embodiment, the temperature is between about 300° C. and about 2,000° C., or optionally between about 500° C. and about 1,500° C. In some embodiments where the metallic layer 120 is formed of gold or silver, the temperature may be a temperature lower than the melting point for gold or silver, and the temperature can be, for example, about 900° C. or 1000° C.

During this step, the metal or alloy of the metallic layer 120 may be in a molten state or mollified state, and may at least partially fill cavities between the oxide particles 130. Such cavities can also be referred to as gaps or spaces. In addition, at least a portion of remnant organic compounds (e.g., a surfactant, such as citrate) that have been used for depositing the oxide particles 130 may be removed. For instance, the organic compounds may be removed by thermal decomposition while the structure of FIG. 1D is heated. In one embodiment, the step may be performed while providing a mixture of nitrogen gas (N₂) and hydrogen gas (H₂) to the structure. For example, the mixture can include about 1% to about 5% of hydrogen gas and about 95% to about 99% of nitrogen gas.

The structure resulting from the step described above in connection with FIG. 1D is cooled naturally or using a fan to room temperature while continuing to press the oxide particles 130 against the thin metallic layer 120. Subsequently, the silicon portion 112 of the substrate 110 is removed from the rest of the structure by, for example, plasma etching (for example, EDP etching using ethylene diamine and pyrocatechol), as shown in FIG. 1E. One example of such plasma etching is described in Reisman et al., Journal of Electrochemical Society, 1979, Vol. 126, pp. 1406-1415, the disclosure of which is incorporated herein by reference in its entirety. A skilled artisan will appreciate that any suitable process (such as wet etching or dry etching) can be used for removing the silicon portion of the substrate 110.

The silicon oxide layer 114 is removed, as shown in FIG. 1F. In one embodiment, the silicon oxide layer 114 may be removed by an etchant, such as but not limited to, hydrogen fluoride (HF) (for example, aqueous HF solution). A skilled artisan will appreciate that any suitable process (such as a process using a buffered oxide etchant) can be used for removing the silicon oxide layer 114. In some embodiments where the oxide particles 130 are formed of a material (for example, silicon oxide) that can be etched by the same etchant, the oxide particles 130 may also be removed at this step, thereby leaving a free-standing membrane having pores.

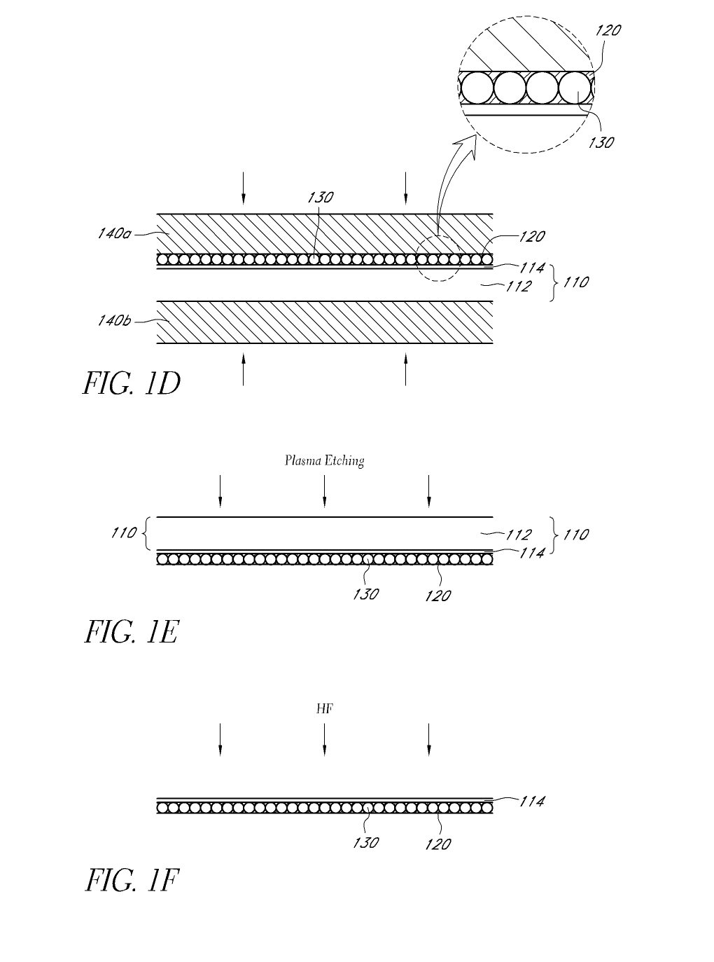

A portion of the resulting metallic porous membrane is shown in FIG. 2. The illustrated membrane 200 includes pores 210 spread on a surface of the membrane 200. The pores 210 may be uniformly or semi-uniformly distributed on the surface of the membrane 200. In certain embodiments, the pores 210 can be non-uniformly distributed. In some embodiments, at least some of the pores 210 may penetrate the membrane 200, thereby forming through-holes. In one embodiment, about 50% to about 100%, or about 70% to about 100% of the pores may form through-holes. The through-holes can have an average diameter of about 1 nm to about 20 nm, or optionally about 3 nm to about 10 nm. The average diameter of the through-holes may be, for example, about 5 nm, or about 12 nm. In other embodiments, the pores 210 may not form through-holes. Formation of such through-holes can be controlled by adjusting the pressure exerted on the oxide particles, as shown in FIG. 1D. Thus, the metallic membrane 210 can be permeable. The pores 210 can be distributed in a pattern in which the oxide particles used as a mold for the membrane 200 are arranged. The membrane 200 can have a thickness between about 1 nm and about 100 nm, or optionally between about 1 nm and about 50 nm. In one embodiment, the pores 210 can have an average size between about 1 nm and about 20 nm. The pore density of the membrane may be about 10% to about 50%, or optionally about 20% to about 40%. The pore density of the membrane can be about 30% or about 40%, for example.

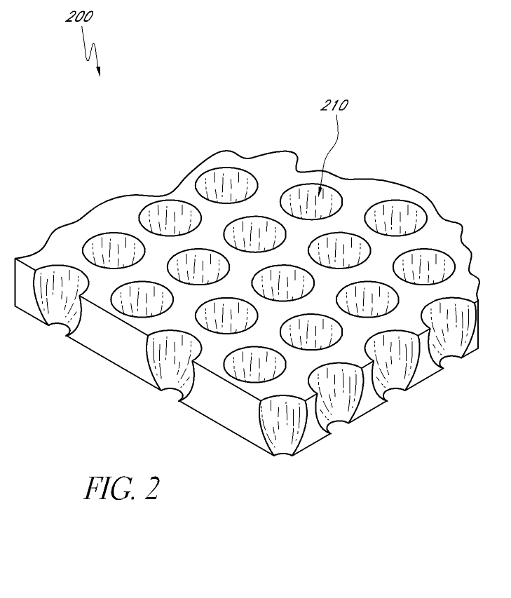

Referring to FIGS. 3A and 3B, methods of making a porous membrane according to one or more embodiments will be described below. First, a substrate 310 having a planarized top surface 311 is provided, as shown in FIG. 3A. The substrate 310 can include a silicon portion 312 and a silicon oxide (SiO₂) layer 314 that forms the top surface 311. The details of the substrate 310 can be as described above with the substrate 110 in connection with FIG. 1A.

A metallic layer 320 can be formed with metallic nanoparticles 322 on the silicon oxide layer 314, as shown in FIG. 3B. The metallic layer 320 may include two or more layers of the nanoparticles 322. The metallic layer 320 can have a thickness between about 5 nm and about 50 nm, or optionally between about 10 nm and about 40 nm. The thickness of the metallic layer 320 can be, for example, about 10 nm, or about 30 nm. In one embodiment, the layer 320 may be deposited by Langmuir-Blodgett (LB) technique. In other embodiments, the layer 320 can be formed by any suitable method, such as spray-coating. The metallic nanoparticles 322 may have an average diameter of about 3 nm to about 20 nm, or optionally about 5 nm to about 15 nm. The average diameter of the nanoparticles can be, for example, about 6 nm or about 10 nm. The metallic nanoparticles 322 may be formed of, for example, Ni, Au, Rd, Ru, Ir, Pd, Os, Ag, Au, Cu, Pt, or a composite of two or more of the foregoing, such as Ru—Pt, Au—Pd, or Fe—Pt. The metallic nanoparticles 322 may be formed by any suitable method, such as a salt-reduction process, for example.

Optionally, the structure shown in FIG. 3A may be subjected to heat treatment to attach the nanoparticles to one another. In one embodiment, the heat treatment may be conducted at a temperature between about 300° C. and about 2,000° C., or optionally between about 500° C. and about 1,500° C. The temperature can be, for example, about 500° C. or 700° C. (for gold nanoparticles, for example). A skilled artisan will appreciate that the temperature can vary widely, depending on the material of the metallic nanoparticles 322.

Oxide particles 330 are provided over the metallic layer 320 such that the oxide particles are closely packed, as shown in FIG. 3B. The oxide particles 330 will together serve as an imprint mold for shaping the metallic layer 320, as will be described below. The details of the oxide particles and this step can be as described above in connection with FIG. 1C.

The oxide particles 330 are pressed against the metallic layer 320. The details of this step can be as described above in connection with FIG. 1D. Then, the resulting structure is cooled to room temperature while continuing to press the oxide particles 330 against the metallic layer 320. Subsequently, the silicon portion 312 of the substrate 310 is removed from the rest of the structure by, for example, plasma etching. The details of this step can be as described above in connection with FIG. 1E.

The silicon oxide layer 314 is removed. In one embodiment, the silicon oxide layer 314 may be etched by an etchant, such as hydrogen fluoride (HF). In some embodiments, the oxide particles are also removed, thereby leaving a free-standing membrane having pores. The details of this step can be as described above in connection with FIG. 1F.

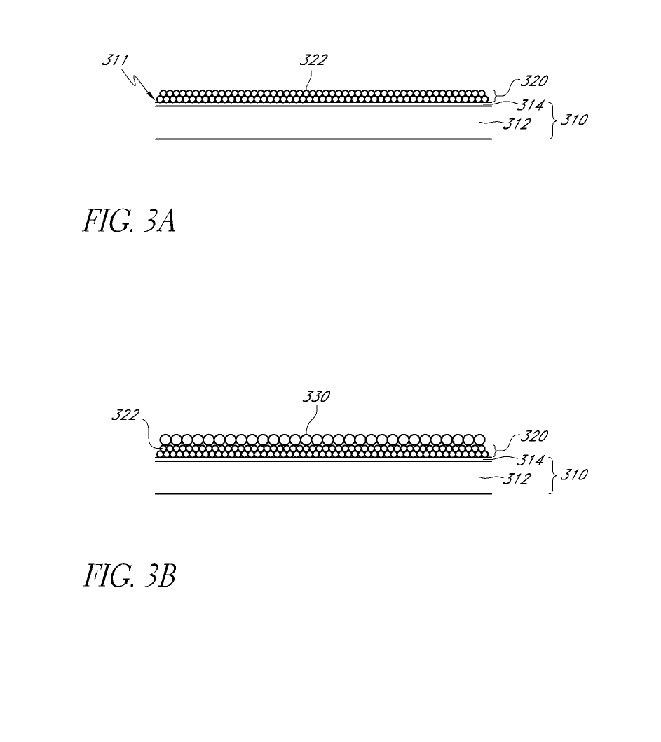

Referring to FIGS. 4A-4C, methods of making a porous membrane according to one or more embodiments will be described below. First, a substrate 410 having a planarized top surface 411 is provided, as shown in FIG. 4A. The substrate 410 can include a silicon portion 412 and a silicon oxide (SiO₂) layer 414 that forms the top surface 411. The details of the substrate 410 can be as described above in connection with FIG. 1A.

A metallic layer 420 can be formed on the silicon oxide layer 414. In one embodiment, the metallic layer 420 may be deposited by an atomic layer deposition (ALD) process, as described above in connection with FIG. 1B. The details of such a step can be as described above in connection with FIG. 1B. In another embodiment, the metallic layer 420 can be formed with metallic nanoparticles, as described above in connection with FIG. 3A. The details of such a step can be as described above in connection with FIG. 3A.

Oxide particles 430 can be provided over a carrier substrate 450 such that the oxide particles are closely packed, as shown in FIG. 4B. The carrier substrate 450 can be formed of, for example, a polymeric material (for example, polydimethylsiloxane (PDMS)). A skilled artisan will appreciate that the carrier substrate 450 can be formed of any suitable material having a relatively low surface energy. The details of the oxide particles can be as described above in connection with FIG. 1C.

The structure shown in FIG. 4A is positioned over the structure shown in FIG. 4B such that the metallic layer 420 faces and contacts the oxide particles 430, as shown in FIG. 4C. In another embodiment, the structure shown in FIG. 4B is positioned over the structure shown in FIG. 4A, such that the metallic layer 420 faces and physically contacts the oxide particles 430.

Then, the two structures of FIGS. 4A and 4B are pressed against each other in a manner similar to that shown in FIG. 1D. The details of this step can be as described above in connection with FIG. 1D. Then, the resulting structure is cooled to room temperature while continuing to press the oxide particles 430 against the metallic layer 420.

The carrier substrate 450 is removed from the structure. In an embodiment where the carrier substrate 450 is formed of PDMS, it can be lifted off from the oxide particles 430. In other embodiments, the carrier substrate 450 can be etched. Subsequently, the silicon portion 412 of the substrate 410 is removed by, for example, plasma etching. The details of this step can be as described above in connection with FIG. 1E.

The silicon oxide layer 414 is removed. In one embodiment, the silicon oxide layer 414 may be removed by an etchant, such as hydrogen fluoride (HF). In some embodiments, the oxide particles may also be removed, thereby leaving a free-standing membrane having pores. The details of this step can be as described above in connection with FIG. 1F.

Methods of making a porous membrane structure according to one or more embodiments will be described below. In one embodiment, a structure can be prepared to include a substrate (which includes, for example, a silicon portion and a silicon oxide layer, a metallic layer, and oxide particles, as described above in connection with FIG. 1C, 3B, or 4C. Subsequently, the oxide particles are pressed against the metallic layer. The details of this step can be as described above in connection with FIG. 1D. Then, the resulting structure is cooled to room temperature while continuing to press the oxide particles against the metallic layer.

Parts of the silicon portion of the substrate are removed by, for example, plasma etching, such that one or more openings” are formed through the silicon portion of the substrate. The openings may be uniformly or semi-uniformly distributed on a surface of the substrate. The openings may have an average diameter of several to several hundred microns, for example, about 50 μm to about 1 mm, or optionally about 200 μm to about 500 μm. The average diameter of the openings may be, for example, about 200 μm or about 500 μm. A skilled artisan will, however, appreciate that the size and shape of the openings can vary widely, depending on the application of the porous membrane structure. As a result, portions of the silicon oxide layer are exposed through the openings. This step can be carried out using any suitable lithographic process.

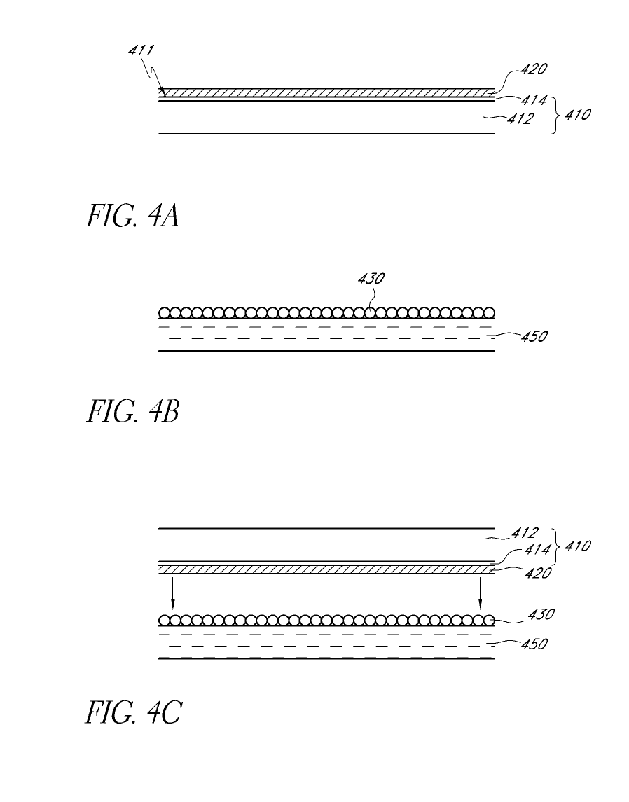

The exposed portions of the silicon oxide layer are removed, thereby exposing portions of the metallic layer. The portions of the silicon oxide layer may be etched by an etchant, such as hydrogen fluoride (HF). In some embodiments, the oxide particles may also be removed, thereby leaving the porous membrane structure shown in FIGS. 5A and 5B.

In the illustrated embodiment, the structure 500 includes a substrate 510 (which includes a silicon portion 512 and a silicon oxide layer 514) and a metallic layer 520. FIG. 5A is a view from the substrate side, and FIG. 5B is a cross-section taken along the line 5B-5B of FIG. 5A. The silicon oxide layer 514 of the substrate 510 is interposed between the silicon portion 512 of the substrate 510 and the metallic layer 520. The substrate 510 includes openings through the silicon portion 512 and the silicon oxide layer 514 thereof The metallic layer 520 is exposed through the openings 510a of the substrate 510. The metallic layer 520 can have a structure, as shown in FIG. 2.

The substrate 510 including the openings can serve as a support structure of the porous membrane 520. This configuration provides structural stability in various applications, as will be described below. Further, the configuration allows the porous membrane 520 to be easily handled in such applications.

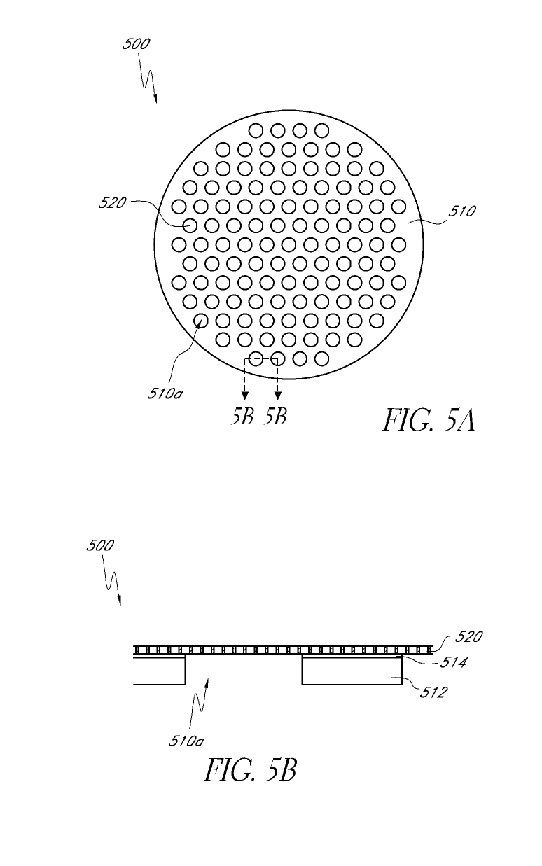

Referring to FIGS. 6A and 6B, methods of making a porous membrane structure according to one or more embodiments will be described below. In the illustrated embodiment, a structure 601 including a substrate 610, a metallic layer 620, and oxide particles 630 is prepared, as described above in connection with FIG. 1C, 3B, or 4C. The substrate 610 includes a silicon portion 612 and a silicon oxide layer 614. In other embodiments, the substrate 610 may be formed of a different material, as described above with respect to FIG. 1A. In the illustrated embodiment, the oxide particles 630 may be formed, for example, of cerium oxide (CeO₂ or CeOx), titanium oxide (TiO₂ or TiOx), or the like.

Subsequently, the oxide particles 630 are pressed against the metallic layer 620. The details of this step can be as described above in connection with FIG. 1D. Then, the resulting structure is cooled to room temperature while continuing to press the oxide particles 630 against the metallic layer 620.

Next, a support substrate 660 is attached (by, for example, contacting and heating) to the structure 601 such that a surface of the support substrate 660 faces and contacts the oxide particles 630 and/or the metallic layer 620, as shown in FIG. 6A. The support substrate 660 may be formed of, for example, carbon, glass, metal, or the like.

Subsequently, the silicon portion 612 of the substrate 610 is removed by, for example, plasma etching. The details of this step can be as described above in connection with FIG. 1E. Finally, the silicon oxide layer 614 is removed. In one embodiment, the silicon oxide layer 614 may be removed by an etchant, such as hydrogen fluoride (HF). The details of this step can be as described above in connection with FIG. 1F. The resulting porous membrane structure 680 is shown in FIG. 6B. The porous membrane structure 680 includes a hetero-structure of a metal oxide (that is, the oxide particles 630) and a metal (that is, the metallic layer 620) on a surface thereof This configuration provides structural stability and easy transferability.

### Applications of Porous Membranes

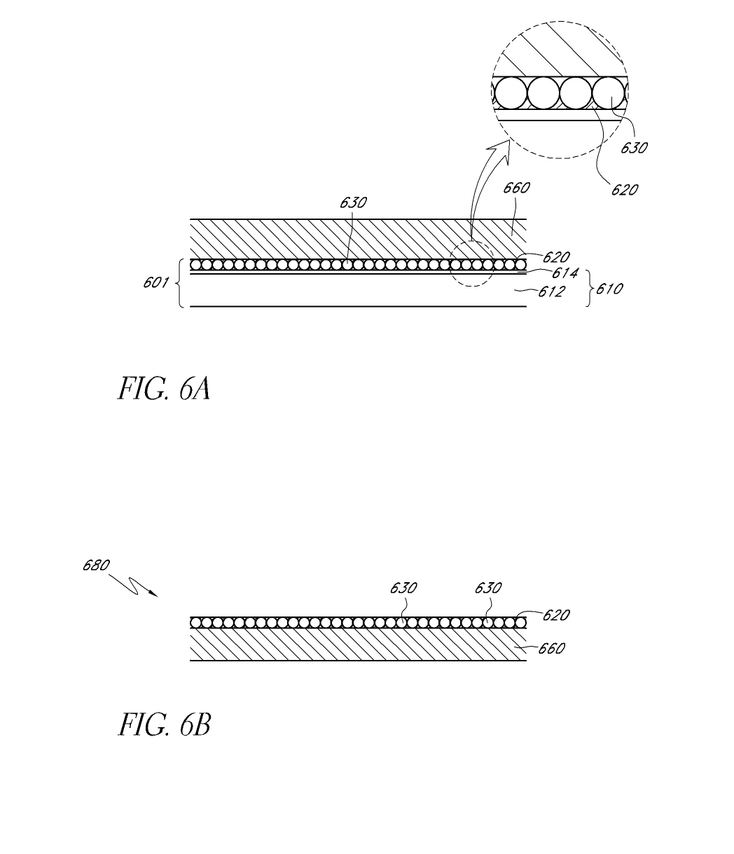

The porous membranes or membrane structures described above can have various applications. Referring to FIG. 7, one embodiment of a porous membrane structure 700 that can be used as a catalyst will be described below. The illustrated structure 700 includes a porous membrane 710 and an electrode 720. The electrode 720 can be formed of any suitable conductive material, such as, but not limited to, copper, gold, silver, etc. The porous membrane 710 covers a surface of the electrode 720. In other embodiments, substantially all surfaces of the electrode may be covered with the porous membrane 710. For example, about 50% to about 90%, or about 60% to about 80% of the surfaces of the electrode may be covered with the porous membrane 710. For example, about 60% or about 70% of the surface of the electrode may be covered with the porous membrane 710. The porous membrane 710 can serve as a catalyst in various chemical reactions.

The porous membrane 710 can be formed by any method described above in connection with FIGS. 1A-1F, 3A-3B, or 4A-4B. In certain embodiments, a porous membrane structure 700 can be made by the method described above in connection with FIGS. 6A and 6B. A skilled artisan will appreciate that various methods can be used for making the structure 700.

In one embodiment, the porous membrane structure 700 can be used in an electrochemical reaction. The electrochemical reaction can be used to amplify signals for sensing biomolecules, such as DNA, RNA, protein, or the like. The porous membrane 710 serves as a catalyst in the reaction while the electrode 720 serves as an anode or cathode in the reaction, as described below.

In another embodiment, the porous membrane structure 700 can be used in a water gas shift (WGS) reaction. In such an embodiment, the porous membrane structure described above in connection with FIG. 6B can be adapted for use in the WGS reaction. For example, the structure can be contacted with a gas such as carbon monoxide and water in order to catalyze their conversion to carbon dioxide and hydrogen. In one embodiment, the oxide particles in such a porous membrane structure may be formed of cerium oxide (CeO₂ or CeOx) or titanium oxide (TiO₂ or TiOx). The metallic layer in the porous membrane structure may be formed of Au. Details of using cerium oxide or titanium oxide in a WGS reaction is described in Rodriguez et al., “Activity of CeOx and TiOx Nanoparticles Grown on Au (111) in the Water-Gas Shift Reaction,” Science, Vol. 318, 1757-1760 (Dec. 14, 2007), the disclosure of which is incorporated herein by reference in its entirety. A skilled artisan will appreciate that any other suitable materials can also be used for the oxide particles and the metallic material for a WGS reaction.

In yet another embodiment, the porous membrane structure 700 can be used in an alcohol-aldehyde reaction. In such an embodiment, the porous membrane structure described above in connection with FIG. 6B can be adapted for use in the alcohol-aldehyde reaction. The oxide particles in such a porous membrane structure may be formed of titanium oxide (TiO₂), for example. The metallic layer in the porous membrane structure may be formed of an alloy of Au—Pd, for example. Details of using Au—Pd/TiO₂ in an alcohol-aldehyde reaction is described in Enache et al., “Solvent-Free Oxidation of Primary Alcohols to Aldehydes Using Au—Pd/TiO₂ Catalyst,” Science, Vol. 311, 362-365 (Jan. 20, 2006), the disclosure of which is incorporated herein by reference in its entirety. An alcohol-aldehyde reaction using this catalyst can be performed at a low temperature without use of a solvent. Because no solvent is not used, such a reaction can be environmentally friendly. A skilled artisan will appreciate that any other suitable materials can also be used for the oxide particles and the metallic material for an alcohol-aldehyde reaction.

In yet another embodiment, a porous membrane formed of gold can be made by the methods described above. In such an embodiment, biomolecules may be attached onto the membrane. The porous membrane may be used in detecting molecules by enhancing the fluorescence of a dye molecule. Details about fluorescence enhancement is disclosed in Ganesh et al., “Enhanced Fluorescence Emission From Quantum Dots On a Photonic Crystal Surface,” Nature Nanotechnology, 2, 515-520 (2007), the disclosure of which is incorporated here by reference.

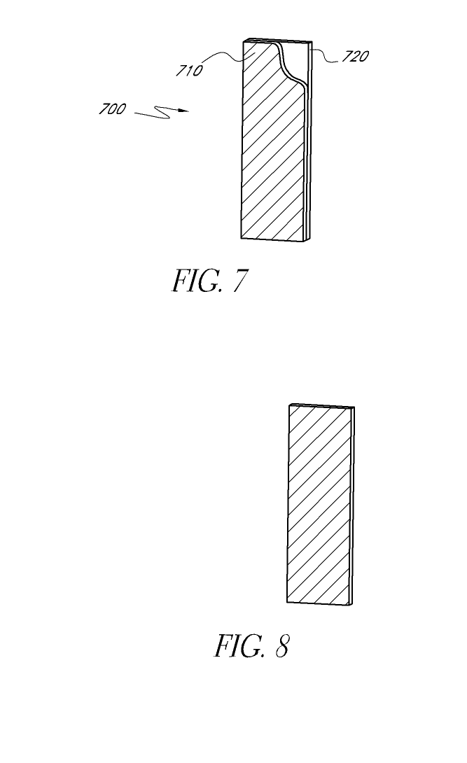

In some embodiments, the porous membrane described above can be used as a free-standing electrode, as shown in FIG. 8. In such embodiments, the metallic layer used for the making the porous membrane is formed of an electrically conductive material, such as, but not limited to, gold, silver, or copper, or an alloy thereof Such a free-standing electrode can be used in electrochemical reactions. In certain embodiments, the porous membrane may be adapted for use as nanoelectrodes in electrocatalytic DNA detection, the details of which is described in Gasparac et al., “Ultrasensitive Electrocatalytic DNA Detection at Two- and Three-Dimensional Nanoelectrodes,” J. AM. CHEM. SOC., 2004, 126, 12280-12271, the disclosure of which is incorporated herein by reference in its entirety.

In other embodiments, the porous membrane described above can be used as a conductor in an electronic or electrical device. In such embodiments, the metallic layer used for the making the porous membrane is formed of electrically conductive material, such as, but not limited to, gold, silver, or copper, or an alloy thereof, for example. The porous membrane can be made very thin and narrow such that it is substantially transparent while providing desired electrical conductivity. In one embodiment, the porous membrane can have a pore size greater than about 100 nm and a thickness of less than about 50 nm. Such porous membranes can be used on a vehicle window as, for example, an antenna component.

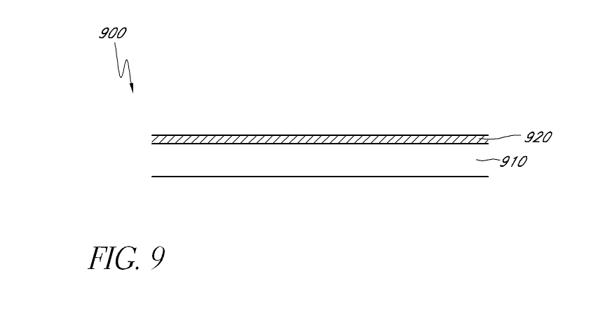

In certain embodiments, the porous membrane described above can be used as a component of a filter. Referring to FIG. 9, in one embodiment, a filter 900 includes a carbon filter layer 910 and a porous membrane 920 attached to the carbon filter layer 910. In such an embodiment, the porous membrane 920 may be formed of, for example, silver or the like. The filter 900 may be used as an antibiotic or virus filter. The filter may be used in an air filter system, a surgical mask, or a gas mask.

In another embodiment, the porous membrane described above can be used as a component of a memory device, for example, a magnetic memory device. In such an embodiment, the porous membrane may be formed of an Ru—Pt alloy, or the like for example. A skilled artisan will appreciate that any suitable materials can be used for making the porous membrane for use as a magnetic memory component.

In other embodiments, the porous membrane described above can be used for making a noble metal-metal oxide composite. As described above with respect to FIG. 6B, a hetero-structure of a metal oxide and a metal can be formed by the methods of the embodiments described above. This allows effective mass manufacturing by making membranes and pulverizing them into power, thereby making a composite material in a powder form.

In at least some of the aforesaid embodiments, any element used in an embodiment can interchangeably be used in another embodiment unless such a replacement is not feasible. It will be appreciated that the steps of the methods described above can be combined, divided, or omitted or that additional steps can be added. It will also be appreciated by those skilled in the art that various other omissions, additions and modifications may be made to the methods and structures described above without departing from the scope of the embodiments.

For purposes of this disclosure, certain aspects, advantages, and novel features of the embodiments are described herein. It is to be understood that not necessarily all such advantages may be achieved in accordance with any particular embodiment. Thus, for example, those skilled in the art will recognize that some embodiments may be embodied or carried out in a manner that achieves one advantage or group of advantages as taught herein without necessarily achieving other advantages as may be taught or suggested herein.

The herein described subject matter sometimes illustrates different components contained within, or connected with, different other components. It is to be understood that such depicted architectures are merely illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method of making a membrane structure, the method comprising:
providing a substrate;
forming a first layer over the substrate, the first layer being formed of a metallic material;
providing a second layer of oxide particles over the first layer; and
pressing the second layer against the first layer such that at least portion of the first layer is inserted into gaps between the oxide particles.

2. The method of claim 1, wherein the first layer has a thickness between about 1 nm and about 100 nm.

3. The method of claim 1, wherein the oxide particles have an average diameter between about 10 nm and about 200 nm.

4. The method of claim 1, wherein forming the first layer comprises forming the first layer with a material selected from the group consisting of Ni, Au, Rd, Ru, Ir, Pd, Os, Ag, Au, Cu, Pt, or a composite or alloy of two or more of the foregoing.

5. The method of claim 1, wherein the oxide particles are formed of a material selected from the group consisting of silicon oxide, cerium oxide, and titanium oxide.

6. The method of claim 1, wherein forming the first layer comprises forming the first layer by atomic layer deposition, chemical vapor deposition, physical vapor deposition, or sputtering.

7. The method of claim 1, wherein forming the first layer comprises depositing a plurality of layers of metallic nanoparticles over the substrate.

8. The method of claim 7, wherein the oxide particles have a first average size and wherein the metallic nanoparticles have a second average size that is smaller than the first average size.

9. The method of claim 8, wherein forming the first layer further comprises subjecting the metallic nanoparticles to heat treatment.

10. The method of claim 8, wherein the first average size is between about 10 nm and about 200 nm, and wherein the second average size is between about 3 nm and about 20 nm.

11. The method of claim 1, wherein providing the second layer comprises:
depositing the oxide particles on a carrier substrate; and
transferring the oxide particles from the carrier substrate onto the first layer.

12. The method of claim 1, wherein providing the substrate comprises providing a substrate including a silicon portion and a silicon oxide layer forming a surface of the substrate.

13. The method of claim 12, wherein the silicon oxide layer is formed of native silicon oxide.

14. The method of claim 12, further comprising, after pressing the second layer:
removing the silicon portion of the substrate; and
removing the silicon oxide layer.

15. The method of claim 14, further comprising removing the oxide particles simultaneously with or after removing the silicon oxide layer.

16. The method of claim 1, further comprising, after pressing the second layer, forming one or more of openings through the substrate such that portions of the first layer are exposed through the openings.

17. The method of claim 1, further comprising, after pressing the second layer: attaching a support substrate to the second layer such that a surface of the support substrate is attached to the oxide particles of the second layer; and
removing the substrate.

18. An apparatus comprising:
a membrane comprising pores formed and distributed in a first surface thereof; and
a substrate attached to a second surface of the membrane opposite the first surface,
wherein the membrane is formed of a metallic material,
wherein the membrane has a thickness between about 1 nm and about 100 nm
wherein the pores have an average size between about 3 nm and about 500 nm, and
wherein the substrate includes one or more openings that expose portions of the second surface of the membrane therethrouph.

19. (canceled)

20. (canceled)

21. (canceled)

22. The apparatus of claim 18, further comprising oxide particles in the pores of the membrane, wherein the oxide particles are formed of a material selected from the group consisting of silicon oxide, cerium oxide, and titanium oxide.

23. (canceled)

24. (canceled)

25. The apparatus of claim 18, wherein the porous membrane is in a form of substantially elongated line.

26. (canceled)

27. The apparatus of claim 18, further comprising a carbon filter layer, wherein the membrane is attached to the carbon filter layer, wherein the metallic material comprises silver.

28. (canceled)

29. (canceled)

30. (canceled)

31. A method of catalyzing an alcohol-aldehyde reaction, comprising:
providing the apparatus according to claim 18 and contacting the apparatus with an alcohol for a period of time sufficient to convert the alcohol to an aldehyde.

32. An electronic or electrical device comprising the apparatus according to claim 18.

33. (canceled)

34. (canceled)
